(19) United States
(12) Patent Application Publication
(10) Pub. No.: US 2022/0265089 A1
(43) Pub. Date: Aug. 25, 2022

(54) BARBECUE GRILL INTERFACE ADHESION-PREVENTION COVER

(71) Applicant: Maine Grilling, LLC, Topsham, ME (US)

(72) Inventor: Robin Copland, Topsham, ME (US)

(73) Assignee: Maine Grilling, LLC, Topsham, ME (US)

(21) Appl. No.: 17/179,607

(22) Filed: Feb. 19, 2021

(51) Int. Cl. A47J 37/07

(52) U.S. Cl. CPC A47J 37/0786

(57) ABSTRACT

A grill interface cover configured to extend over at least a portion of the upper interior surface of a grill having a base perimeter and a lid perimeter where cold adhesion may occur. The interface cover is positioned between the lid and the base when the lid is closed. The interface cover may be configured for covering only those surfaces where the base perimeter otherwise contacts the lid perimeter. Alternatively, the insert cover may extend over those contact surfaces as well as the interior space between the lid and the base, such as the food support grate, for example.

### BACKGROUND OF THE INVENTION

### 1. Field of the Invention

The present invention relates to barbecue grills having a lid and a base. More particularly, the present invention relates to an interface cover that can be added to a barbecue grill at the interface of the lid and the base. The cover prevents adhesion of the lid to the base at the interface under environmental conditions that would otherwise cause the lid and the base to stick together.

### 2. Description of the Prior Art

Barbecue grills are widely used to cook foods of all sorts. Most grills comprise a lid and a base where a cooking element is positioned. The cooking element may be a gas-fired burner or burners, and/or fuel such as wood pellets or charcoal. A cooking surface grate is positioned over the cooking element and is used to support food items over the cooking element. The lid is used to enclose the grill, trapping heat in the space between the lid and the base to speed the cooking process. The lid may or may not be rotatably attached to the base at a hinge to allow for opening and closing the grill to access the food within.

While the present invention is not limited to a specific type of grill, there are certain grills that include a gasket at the lid-to-base interface. The gasket is designed to seal that interface and minimize heat transfer out of the grill. For example, Kamado-type grills have such a gasket component. Specifically, there is a lid gasket extending completely or substantially around the entire the inner perimeter of the lid, and a base gasket extending completely or substantially around the entire inner perimeter of the base. For those grills configured with a lid gasket and a base gasket, those two gaskets contact each other to form an insulative interface. For grills with only a lid gasket or a base gasket, the gasket provides an insulative interface with the opposing lid perimeter or base perimeter. These grill gaskets are often made of felt but not limited thereto. It is to be noted that the present invention may be used with lidded grills without any insulative gasket.

Grill covers are widely available that extend over the lid and cover at least a portion of the exterior of the grill. These exterior covers are helpful to limit moisture passing into the interior of the grill. Unfortunately, that is the limit of their utility. Under certain environmental conditions including damp and cold conditions, moisture may freeze the lid gasket and base gasket together when the grill is not in use, rendering it difficult to open the grill and/or causing gasket damage when it is to be used. The exterior grill cover does not prevent this occurrence. As a result, when lid-to-base adhesion occurs, the grill either goes unused, must be repaired, or is compromised when gasket adhesion and/or damage occurs. There has been no known effective means for limiting or preventing gasket-to-gasket adhesion. Therefore, what is needed is a means to limit or prevent gasket-to-gasket adhesion. More generally, what is needed is a means to limit or prevent adhesion of a grill lid to a grill base, whether at the gasket-to-gasket interface or any other sort of lid-to-base interface. Further, what is needed is such means for adhesion limitation or prevention that is convenient to use, is reusable, and is reasonably priced.

### SUMMARY OF THE INVENTION

It is an object of the present invention to provide an apparatus that can be used to limit or prevent grill gasket-to-gasket adhesion. It is also an object of the present invention to provide ad apparatus to limit or prevent adhesion at any lid-to-base interface of a grill. Further, it is an object of the present invention to provide such an apparatus that is convenient to use, is reusable, and is reasonably priced.

These and other objects are achieved with the present invention, which is a grill interface cover configured to extend over at least a portion of the upper interior surface of the grill base. The interface cover is positioned between the lid and the base when the lid is closed. If the grill owner has an exterior grill cover, the interface cover of the present invention is located within that exterior grill cover. The interface cover may be configured for covering only those surfaces where the base perimeter otherwise contacts the lid perimeter. Alternatively, the interface cover may extend over those contact surfaces as well as the interior space between the lid and the base, such as the food support grate, for example.

The interface cover may be secured in position around the outer perimeter of the base or the outer perimeter of the lid at the lid-to-base interface. It may be attached to the outer body of the base, cinched around the outer body of the base such as with a strap, or it may extend beyond the outer perimeter of the top of the base and held in place by the closed lid. The cover is fabricated of a material sufficient to be used for an extended time in the type of environmental conditions that would otherwise cause gasket adhesion.

The present invention serves to prolong the life of a grill interface gasket or gaskets. It thereby saves the grill owner that maintenance expense. The interface cover also allows the grill owner to use the grill regardless of environmental conditions that otherwise would limit access to the grill or limit its usage if a gasket is damaged. The interface cover is fabricated of a reasonably priced material such as a nonmetallic material, such as a viscoelastic material like silicone or polyethylene but not limited thereto. These advantages of the invention will become more apparent upon review of the following detailed description, accompanying drawings and appended claims.

### BRIEF DESCRIPTION OF THE DRAWINGS

FIG. 1 is a front perspective view of a grill having a lid and a base with the lid partially open to show a first embodiment of the interface cover of the present invention in position on the grill base.

FIG. 2 is a top view of the first embodiment of the insert cover of FIG. 1.

FIG. 3 is a front perspective view of a grill having a lid and a base with the lid partially open to show a second embodiment of the interface cover of the present invention in position on the grill base.

FIG. 4 is a top view of the second embodiment of the insert cover of FIG. 3.

FIG. 5 is a front perspective view of a grill having a lid and a base with the lid partially open to show a third embodiment of the interface cover of the present invention in position on the grill base.

FIG. 6 is a top view of the third embodiment of the interface cover of FIG. 5.

### DETAILED DESCRIPTION OF THE INVENTION

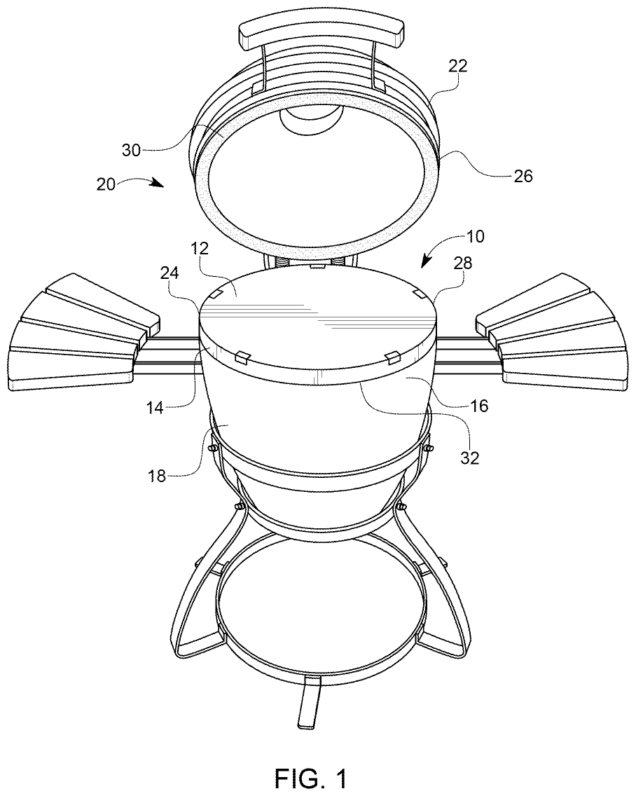

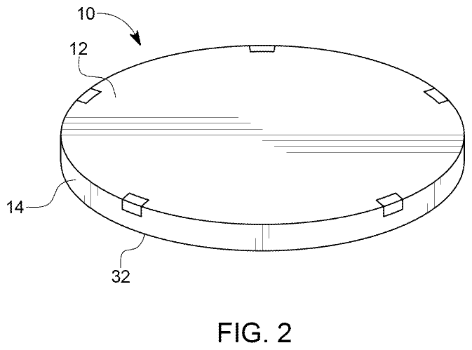

A first embodiment of a grill interface cover 10 of the present invention is shown in FIGS. 1 and 2. The cover 10 includes a body 12 and a perimeter 14. The cover 10 is sized and shaped to extend over a top portion 16 of a base 18 of a grill 20. The grill 20 includes the base 18 and a lid 22. The base 18 includes a base perimeter 24 and the lid 22 includes a lid perimeter 26. In the example grill shown in the drawings, the base 18 includes a base gasket 28 within the base perimeter 24 and the lid includes a lid gasket 30 within the lid perimeter 26. The cover 10 and the grill 20 are shown to be round; however, the present invention is not limited to the cover 10 specifically being round. Instead, it may be oval or rectangular, for example, to fit grills of different shapes.

The cover 10 is made of a material such as a polyester material, a vinyl-coated polyester, a Kevlar material, a vinyl-coated Kevlar material, other materials, or a combination of materials. It may be stretchable material or not stretchable material. It is of selectable thickness. The material chosen to make the cover 10 is selected to maintain its structural integrity in wet and/or cold conditions. More specifically, the material of the cover 10 is chosen to prevent cold adhesion of the lid 22 to the base 18, whether at the perimeters or the gaskets thereof. The cover 10 is therefore configured to extend over the base perimeter 24 to ensure it functions as a new interface of the base 18 to the lid 22, whether at perimeters 24 and 26 or at gaskets 28 and 30.

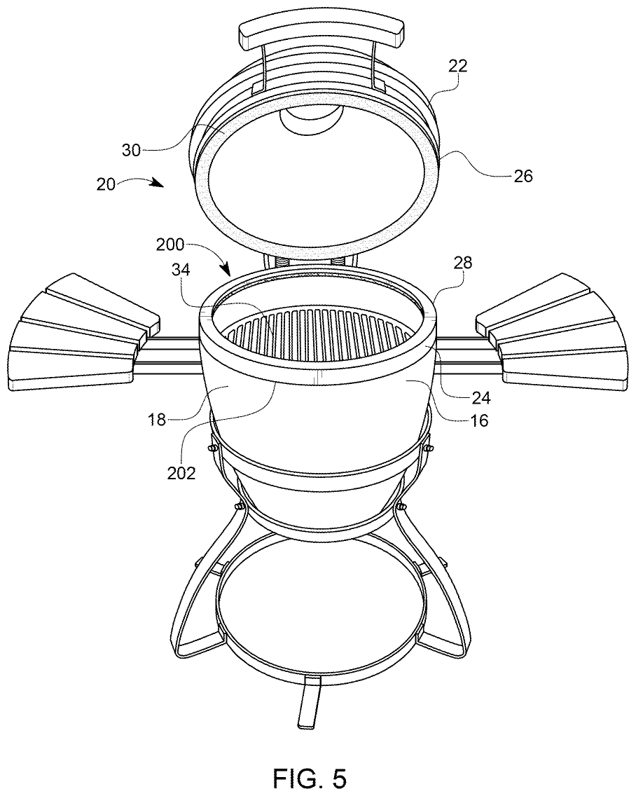

The cover 10 may be removably secured in place to the grill 20 when the grill 20 is not in use by closing the lid 22 onto the base 18 as normally occurs when a grill is not in use. The lid 22 holds the cover 10 in place by trapping it to the base 18. Alternatively, the perimeter 14 of the cover 10 may include a cinching member 32, such as a string or an elastic, that is joined to the perimeter 14. The cinching member 32 may be released when the cover 10 is to be removed and cinched into place to secure the cover 10 about the base 18. In the embodiment of the invention shown in FIGS. 1 and 2, the body 12 of the cover 10 is substantially or partially solid and covers the entirety of a grate 34 (shown in FIG. 5) of the grill 20 as well as the base gasket 28. It is to be understood that the cover 10 could be removably applied about the lid at the opening thereof to include covering the lid gasket 30.

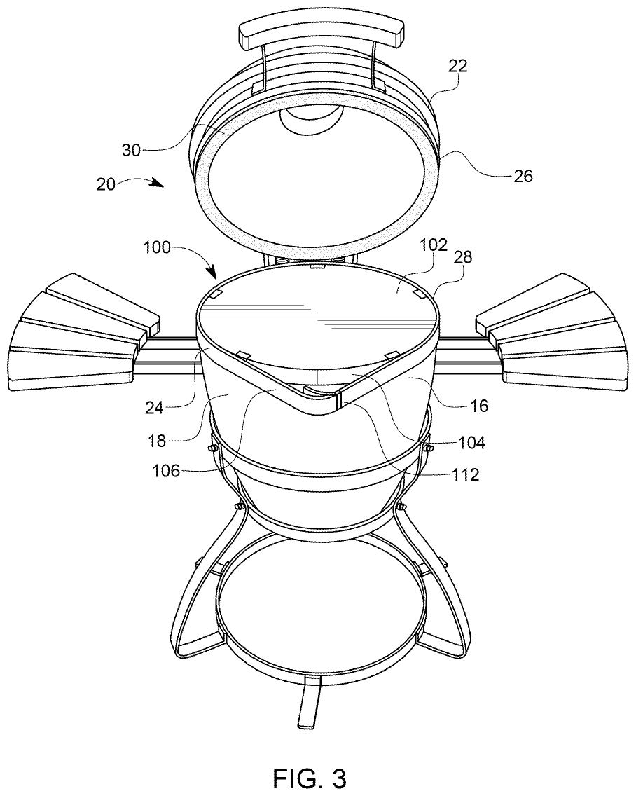

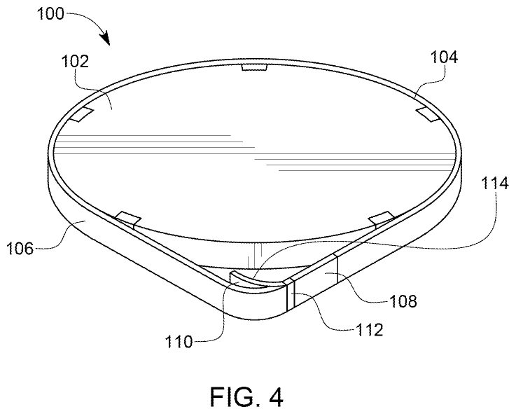

A second embodiment of a grill insert cover 100 of the present invention is shown in FIGS. 3 and 4. The cover 100 includes a body 102 and a perimeter 104. The cover 100 is sized and shaped to extend over the top portion 16 of the base 18 of the grill 20. The cover 100 is shown to be round; however, the present invention is not limited to the cover 100 specifically being round. Instead, it may be oval or rectangular, for example, to fit grills of different shapes.

The cover 100 is made of a material such as a polyester material, a vinyl-coated polyester, a Kevlar material, a vinyl-coated Kevlar material, other materials, or a combination of materials. It may be stretchable material or not stretchable material. It is of selectable thickness. The material chosen to make the cover 100 is selected to maintain its structural integrity in wet and/or cold conditions. More specifically, the material of the cover 100 is chosen to prevent cold adhesion of the lid 22 to the base 18, whether at the perimeters or the gaskets thereof. The cover 100 is therefore configured to extend over the base perimeter 24 to ensure it functions as a new interface of the base 18 to the lid 22, whether at perimeters 24 and 26 or at gaskets 28 and 30.

The cover 100 is removably secured in place to the grill 20 about the base perimeter 24 and the grill 20 with a belt 106. The belt 106 includes a first end 108 and a second end 110. The first end 108 includes a buckle 112 and the second end includes a strap 114 that is engageable with the buckle 112. The strap 114 may include multiple ports into which a prong of the buckle 112 may be inserted for adjustment of tightening of the cover 100 about the base perimeter 24. The belt 106 holds the cover 100 in place about the base 18. Other means for removably retaining the first end 108 and the second end 110 together are possible including, but not limited to, Velcro, magnets, or other suitable attachment mechanism. In the embodiment of the invention shown in FIGS. 3 and 4, the body 102 of the cover 100 is substantially or partially solid and covers the entirety of a grate 34 (shown in FIG. 5) of the grill 20 as well as the base gasket 28. It is to be understood that the cover 100 could be removably applied about the lid at the opening thereof to include covering the lid gasket 30.

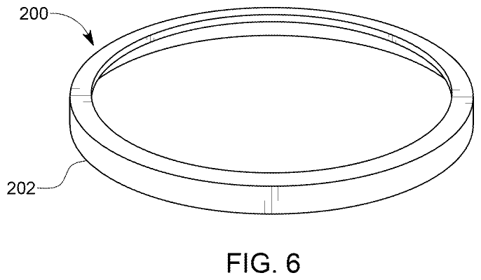

A third embodiment of a grill insert cover 200 of the present invention is shown in FIGS. 5 and 6. The cover 200 is of an annular shape and is made of a material such as a polyester material, a vinyl-coated polyester, a Kevlar material, a vinyl-coated Kevlar material, other materials, or a combination of materials sufficiently flexible to allow it to be draped over the base gasket 28 to cover that base gasket 28 without also covering the grate 34. It may be stretchable material or not stretchable material. It is of selectable thickness. The material chosen to make the cover 200 is selected to maintain its structural integrity in wet and/or cold conditions. More specifically, the material of the cover 200 is chosen to prevent cold adhesion of the lid 22 to the base 18, whether at the perimeters or the gaskets thereof. The cover 200 is therefore configured to extend over the base perimeter 24 to ensure it functions as a new interface of the base 18 to the lid 22, whether at perimeters 24 and 26 or at gaskets 28 and 30.

The cover 200 may be removably secured in place to the grill 20 when the grill 20 is not in use by closing the lid 22 onto the base 18 as normally occurs when a grill is not in use. The lid 22 holds the cover 200 in place by trapping it to the base 18. Alternatively, the cover 200 may include a cinching member 202, such as a string or an elastic, that is joined to the perimeter 24 of the cover 200. The cinching member 202 may be released when the cover 200 is to be removed and cinched into place to secure the cover 200 about the base 18. It is to be understood that the cover 200 could be removably applied about the lid at the opening thereof to include covering the lid gasket 30.

The invention has been described with respect to specific embodiments. It is not intended to be limited thereto but instead by the scope of the claims and their equivalents.

What is claimed is:

1. A grill interface cover arranged to prevent adhesion of a lid to a base of the grill, wherein the lid includes a lid perimeter, and the base includes a base perimeter, the cover comprising:
a body; and
a perimeter,
wherein the body and the perimeter of the grill are configured to cover the lid perimeter and/or the base perimeter of the grill, and
wherein the cover may be removably secured in place to the grill when the grill is not in use.

2. The grill interface cover of claim 1, further comprising a strap coupled to the perimeter of the cover, wherein the strap enables adjustable and removable retention of the cover to the lid perimeter and/or the base perimeter.

3. The grill interface cover of claim 1, wherein the body and the perimeter are fabricated of a material sufficient to prevent adhesion of the lid to the base under cold and/or moist weather conditions.

4. The grill interface cover of claim 1, wherein the body and the perimeter of the cover are arranged to cover the base perimeter and a grate of the grill.

5. The grill interface cover of claim 1, wherein the body and perimeter of the cover are arranged to cover only the base of the perimeter and not a grate of the grill.

6. The grill interface cover of claim 1, wherein the cover is fabricated of a stretchable material.

7. The grill interface cover of claim 1, further comprising a cinching member of the perimeter to removably retain the cover to the base of the grill.
